(19) United States
(12) Patent Application Publication
(10) Pub. No.: US 2023/0157220 A1
(43) Pub. Date: May 25, 2023

(54) METHOD FOR INITIATING A PLANT IN PREPARATION OF ITS INTRODUCTION INTO A VERTICAL FARM UNIT

(71) Applicant: Ferme d'Hiver Technologies Inc., Brossard (CA)

(72) Inventors: Yves DAOUST, Saint-Lambert (CA); Kashif RIAZ, Saint-Lambert (CA)

(21) Appl. No.: 17/989,893

(22) Filed: Nov. 18, 2022

Related U.S. Application Data
(60) Provisional application No. 63/281,350, filed on Nov. 19, 2021.

(51) Int. Cl. A01G 9/029; A01G 27/00; A01C 21/00; A01G 9/02; A01G 7/04; G05B 19/416

(52) U.S. Cl. CPC A01G 9/0299; A01G 27/003; A01C 21/007; A01G 9/023; A01G 7/045; G05B 19/416; H05B 47/11

(57) ABSTRACT

An apparatus for growing plants comprises two towers located adjacent to each other and forming an outside perimeter surface, a tray located in the bottom of the outside perimeter surface; and a cable system configured to pull a plurality of pods along the outside perimeter, each pod having containers, the cable system configured to bring at least one pod in a contact with a liquid located in the tray. A plant growth monitoring system comprises a plurality of sensors, a plurality of distributors configured to distribute fertilizers in response to received commands, and a controller configured to receive a sensor data from the plurality of sensors, determine commands for a stage of growth of plants based on a sensor data received and transmit the commands to the distributors. A method of initiating a plant in preparation of its introduction into a vertical farm unit is also disclosed.

### RELATED APPLICATION

The present application claims priority to or benefit of U.S. provisional patent application No. 63/281,350, filed Nov. 19, 2021, which is incorporated herein by reference in its entirety.

### TECHNICAL FIELD

The present disclosure relates to growing plants. More specifically, it relates to methods and apparatuses for initiating a plant in preparation of its introduction into a vertical farm unit.

### BACKGROUND

Year-round provision of fresh, ready to produce nursery stock of plants has been a problem due to various factors that may influence the growth of the plants. In artificial conditions, plants may be grown in vertical agriculture modules. However, growing the plants from seeds and other propagation materials in such vertical agriculture modules is not easy but laborious, time and space consuming, and conditions of nurturing plants at their initial stages of growth generally differ from the conditions of growing mature plants.

### SUMMARY

According to an aspect of the invention, there is provided an apparatus for growing plants, the apparatus comprising:
a first tower and a second tower located adjacent to each other and forming an outside perimeter surface, the outside perimeter surface comprising two surfaces of opposite sides of the first tower, two surfaces of opposite sides of the second tower, and bottom portions of the first and the second towers;
a tray located in the bottom of the outside perimeter surface; and
a cable system configured to pull a plurality of pods along the outside perimeter, each pod having two containers positioned parallel to each other and to the outside perimeter surface, the cable system having a deepest wheel configured to bring at least one pod of the plurality of pods in a contact with a liquid located in the tray.

According to an embodiment, the cable system comprises gears and a chain, the deepest wheel being one of the gears.

According to an embodiment, there is further a controller configured to operate a motor for pulling the cable system along the outside perimeter surface.

According to an embodiment, the tray has tray wheels for moving independently of the first tower and the second tower, wherein the first tower and the second tower are immovable with respect to each other.

According to an embodiment, there is further a controller configured to control a depth of the contact of the at least one pod with the liquid located in the tray.

According to an embodiment, there is further provided:
a plurality of sensors;
a plurality of distributors configured to distribute fertilizers in response to received commands; and
a controller configured to:
   receive a sensor data from the plurality of sensors,
   determine commands for a stage of growth of plants based on plant identifications and the sensor data;
   transmit the commands to the distributors to deliver the fertilizers to the tray and the containers, wherein at least one of the fertilizers is distributed to the tray.

According to another aspect of the invention, there is provided a plant growth monitoring system comprising:
a plurality of sensors;
a plurality of distributors configured to distribute fertilizers in response to received commands; and
a controller configured to:
   receive a sensor data from the plurality of sensors, determine commands for a stage of growth of plants;
   transmit the commands to the distributors.

According to another aspect of the invention, the distributors are configured to mix fertilizer components to produce the fertilizers.

According to another aspect of the invention, determining commands for a stage of growth of plants is based on pot identifications related to the plants and received by the controller.

According to another aspect of the invention, the controller is further configured to control the heating, ventilation and air conditioning system based on the stage of growth of the plants.

According to another aspect of the invention, there is provided a method of initiating a plant in preparation of its introduction into a vertical farm unit, the method comprising:
treating frozen and/or fresh sprouts with a chemical for an initial period of time in an isolated chamber to obtain plant-ready sprouts;
planting the plant-ready sprouts in pots with soil or grow substrate and identifying the pots with pots identifications; and
placing the pots in an apparatus and adjusting plant environment conditions for the pots.

According to another aspect of the invention, there is provided a method of initiating a plant in preparation of its introduction into a vertical farm unit, the method to be performed in a system comprising:
an apparatus configured to revolve pods with sprouts to periodically expose different sprouts placed in the pods to plant environment conditions,
a controller having a processor and configured to determine and request to modify the plant environment conditions,
a plurality of sensors;

the method comprising:
planting plant-ready sprouts in pots with soil or grow substrate and identifying the pots with pots identifications (IDs);
placing the pots in the pods of the apparatus; and
determining by the controller and adjusting the plant environment conditions for the pots based on received pot Ds, growth state and sensor data received from the plurality of sensors.

According to an embodiment, there is further provided the step of, prior to planting the plant-ready sprouts, treating frozen and/or fresh sprouts with a treatment solution for an initial period of time in an isolated chamber to obtain the plant-ready sprouts.

According to an embodiment, adjusting the plant environmental conditions comprises temperature based on a temperature value determined by the controller.

According to an embodiment, adjusting the plant environmental conditions comprises adjusting lighting based on a spectrum and intensity determined by the controller.

According to an embodiment, adjusting the plant environmental conditions comprises adjusting humidity based on humidity value determined by the controller.

According to an embodiment, adjusting the plant environmental conditions comprises providing or adjust of providing fertilizers to the plants in an amount and type as determined by the controller.

According to an embodiment, there is further provided the step of distributing fertilizers in response to received commands from the controller.

According to an embodiment, the controller determines the plant environment conditions by using convolutional neural networks (CNN).

According to an embodiment, there is further provided the step of adjusting a pod revolving speed in response to received commands from the controller.

### BRIEF DESCRIPTION OF THE DRAWINGS

Further features and advantages of the present disclosure will become apparent from the following detailed description, taken in combination with the appended drawings, in which:

FIG. 1 is a perspective view of an apparatus, in accordance with at least one embodiment of the present disclosure;

FIG. 2 is a perspective view of a body of the apparatus with a monitoring system, in accordance with at least one embodiment of the present disclosure;

FIG. 3A is a front view of the apparatus of FIG. 1;

FIG. 3B is a side view of the apparatus of FIG. 1;

FIG. 4A is a front view of a body of the apparatus of FIG. 1;

FIG. 4B is a side view of the body of the apparatus of FIG. 1;

FIG. 4C is an enlarged portion the apparatus of FIG. 4B;

FIG. 5A is an enlarged portion of the apparatus depicted in Hg. 1 depicting a tray;

FIG. 5B is an enlarged portion of the body depicted in FIG. 4B depicting the tray;

FIG. 5C is an enlarged portion of FIG. 5B;

FIG. 5D depicts a top view of a pod of the apparatus of FIG. 1;

FIG. 6 is a schematic diagram depicting a monitoring system in accordance with at least one embodiment of the present disclosure;

FIG. 7 schematically illustrates a growth cycle and transmission of the sensor data and requirements in time, in accordance with at least one embodiment of the present disclosure;

FIG. 8 illustrates a joint greenhouse having a first greenhouse building and a second greenhouse building, in accordance with at least one embodiment of the present disclosure;

FIG. 9A illustrates a pallet with sprouts, in accordance with at least one embodiment of the present disclosure;

FIG. 9B illustrates a pot with the sprout, in accordance with at least one embodiment of the present disclosure;

FIG. 10 illustrates a method of initiating a plant in preparation of its introduction into a vertical farm unit, in accordance with an embodiment of the present disclosure; and

FIG. 11 illustrates a method of initiating a plant in preparation of its introduction into a vertical farm unit, in accordance with another embodiment of the present disclosure.

It will be noted that throughout the appended drawings, like features are identified by like reference numerals.

### DETAILED DESCRIPTION

Various aspects of the present disclosure generally address one or more of the problems of growing plants at the initial stages of their growth. The apparatus and a monitoring system as described herein provides a solution to a problem of growing plants year-round by addressing the main physiological requirements of the plants continuously during initial stages of the plant growth.

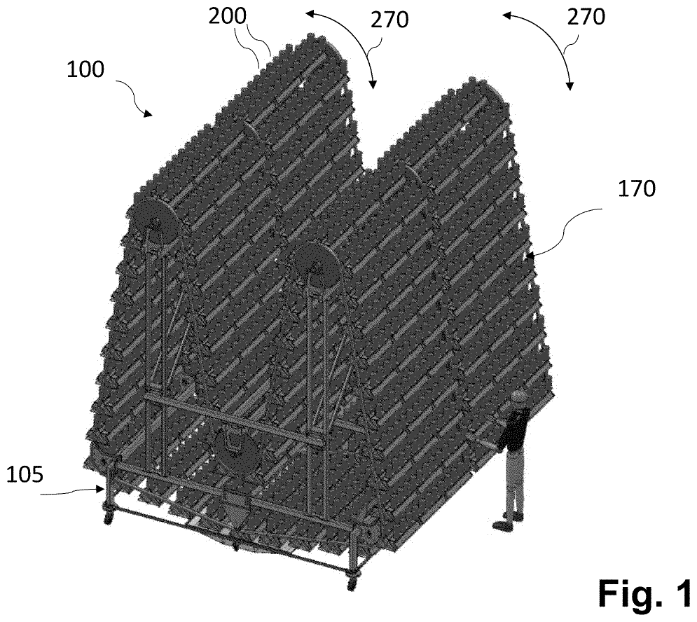

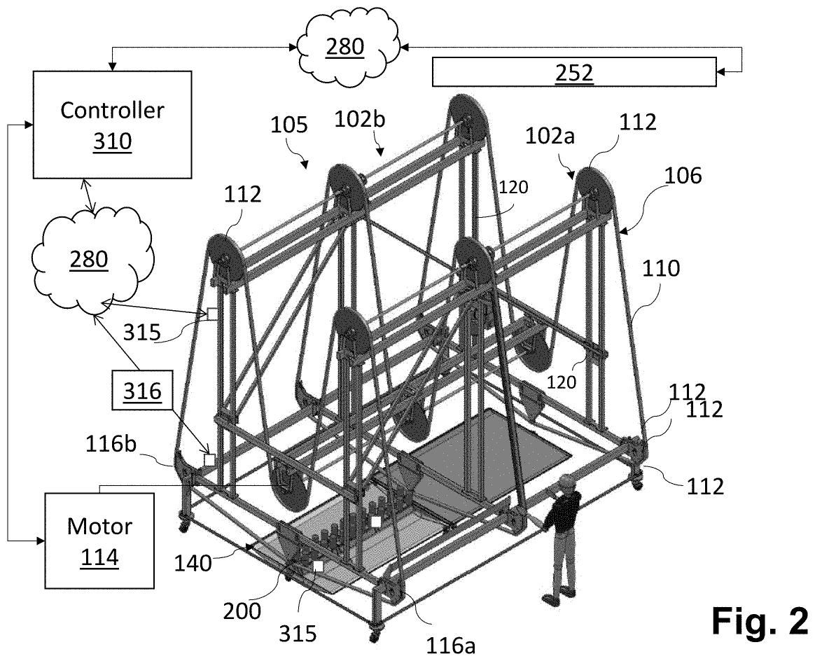

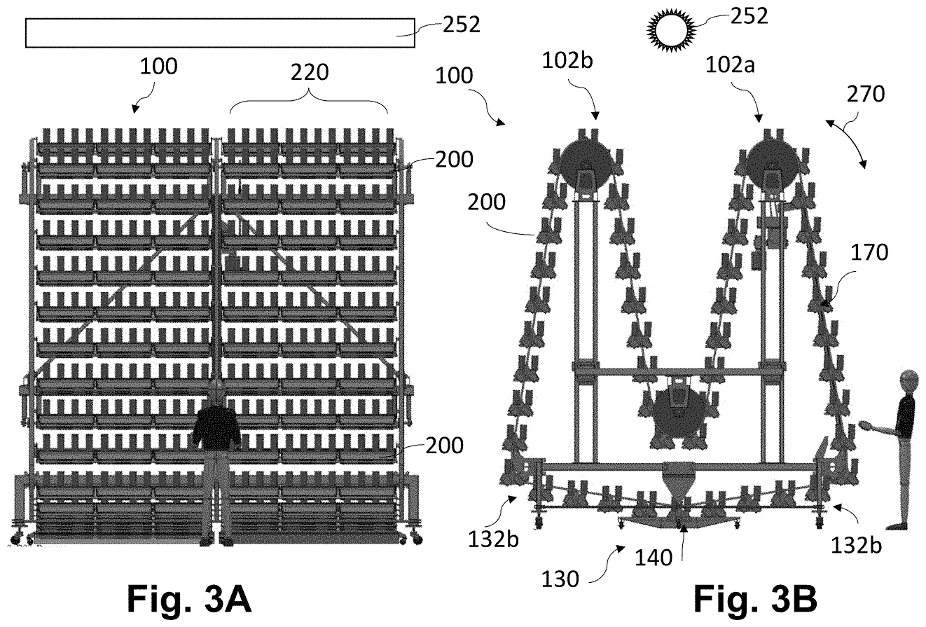

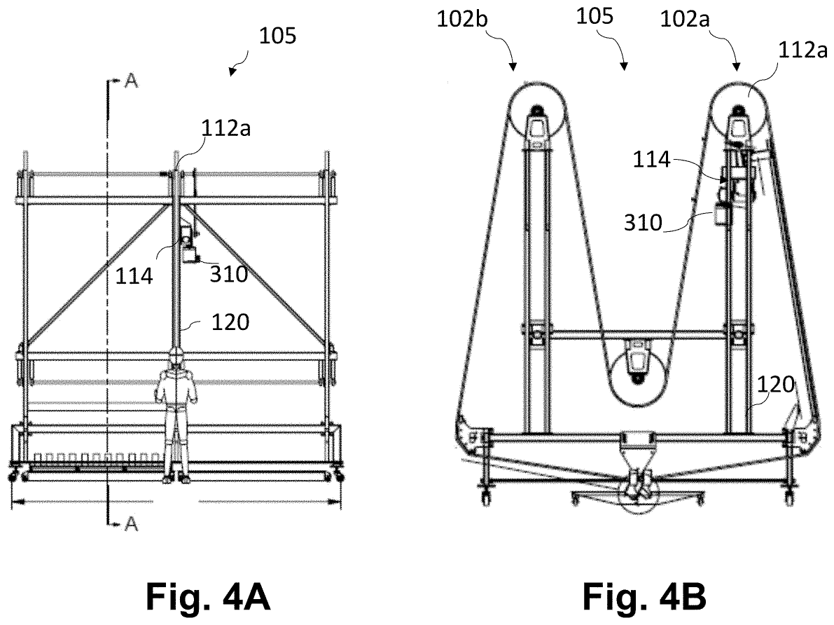

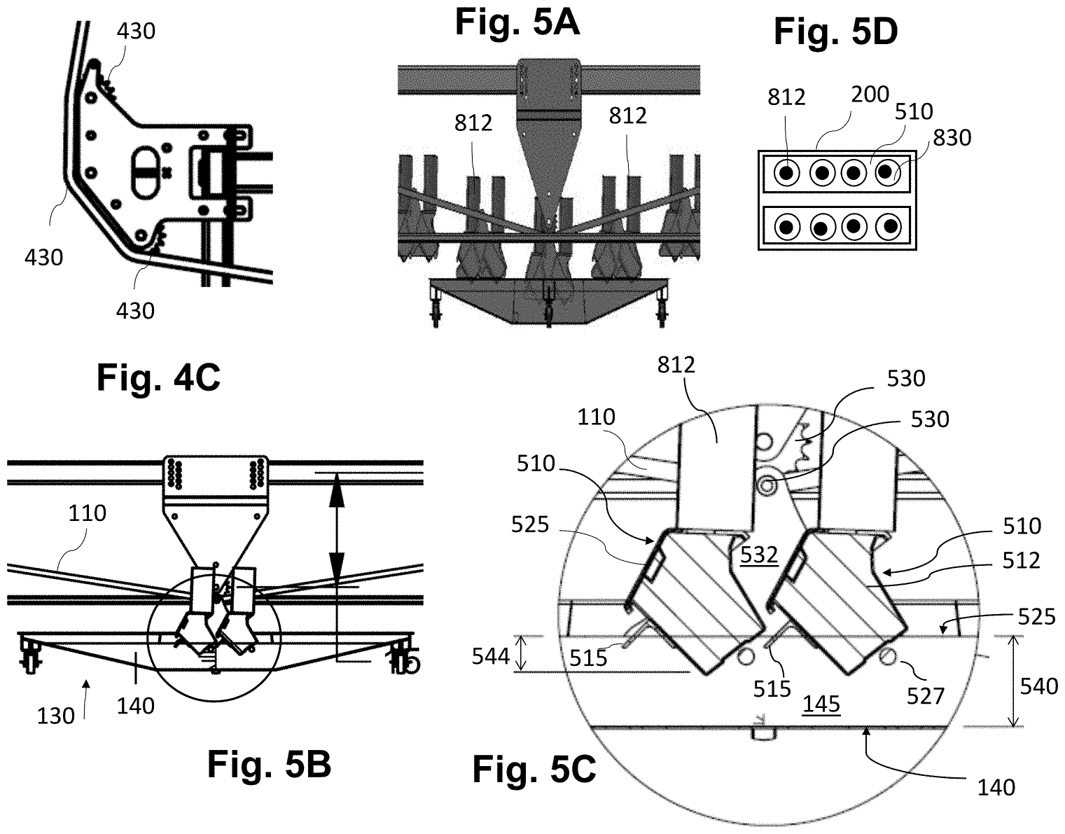

Referring now to the drawings, FIG. 1 shows an example of an apparatus 100 (also referred to herein as “cradle 100”) for plant growth. The apparatus 100 comprises a body 105 (depicted also in FIGS. 2, 4A, 4B) and plant pods 200. As illustrated in FIGS. 2, 3B and 4B, the body 105 has two towers 102a, 102b and a cable system 106.

The cable system 106 comprises a cable 110 and pulling wheels 112 (which may be also referred to as a “system of pulling wheels”) connected to a motor 114 schematically depicted in FIG. 2. The cable 110 may be implemented as a chain, and the pulling wheels 112 may be implemented as gears. The gears 430 are illustrated in FIG. 4C, and a gear 530 is depicted, for example, in FIG. 5C. The motor 114 is configured to rotate at least one of the pulling wheels 112 such that the cable 110 is pulled from one pulling wheel 112 to another pulling wheel 112. The motor 114 may be connected to one of the pulling wheels 112 (gears 430, 530) as illustrated in FIG. 2. In at least one embodiment, the motor 114 and controller 310 illustrated in FIG. 2 may be attached to one of columns 120 of one of towers 102a, 102b and the motor 114 may rotate the upper pulling wheel(s) 112a as illustrated in FIGS. 4A and 4B.

Plant pods 200 may be organized in pod sets 220 which are attached to the cable system 106 such that the pod sets 220 are moved (displaced) along with the displacement of the cable 110 in the apparatus 100. Referring to FIGS. 1-3B, the pod sets 220 are displaced first from the bottom of a first tower 102a towards the top of the first tower 102a, then towards the bottom of the first tower 102a on an opposite side of the first tower 102a, and then towards the top of a second tower 102b, and then towards the bottom of the second tower 102b on an opposite side of the second tower 102b. Similarly, the pot sets 220 may be moved in the opposite direction, as illustrated with arrows 270.

When the pod set 220 has reached the bottom of the second tower 102b, the bottom wheel 116b of the cable system 106 located on the second tower 102b leads the cable 110 and the pod set 220 attached thereto underneath the second tower 102b to a bottom section 130 of the apparatus 100. The bottom section 130 of the apparatus 100 hosts a portion of the cable 110 extended between two extreme sides 135a, 135b of the apparatus 100, and a tray 140.

Referring now to FIG. 5A-5C, in operation, the pods 200 attached to, and pulled by the cable 110, pass by the tray 140 in such a way that when the tray 140 has a liquid 145, a portion of the pod 200 dips into the liquid 145 thus providing watering to the plant roots growing in the pods 200. In other terms, the pods 200 form an irrigation cradle that permits to provide submersive watering and root treatments to the plants located and growing inside the pods 200.

The configuration of the apparatus 100 with two towers 102a, 102b permits all plants to be revolved and be exposed to the light and water evenly and periodically. The light is a combination of a daylight (sun light during the day) and a supplementary artificial light provided by a supplemental light system 252 (FIG. 2). The apparatus 100 permits conditioning the roots of plants while pots or pods, in which the plants are planted, revolve (are in motion) and thus offers adequate initiation or priming for subsequent plant production. In addition, such a configuration may permit achieving uniform growth and a synchronized delivery of multiples of thousands of plants (sprouts grown to plants). The system and the method described herein may allow: a) 24-hour monitoring of plant physiological processes, b) provision of ideal growth conditions, c) proper nutrition, and d) cultural practices for proper maintenance of plants at their initial growth stages. In other terms, the system and method described herein provide means for nurturing the plant sprouts in order to deliver them to vertical agriculture modules for further vegetative growth and producing harvest.

In some embodiments, the plants are strawberry plants. The plants may be, for example: strawberry plug plants, bare root plants and strawberry seeds. The plants, when they are located and nurtured by the cradle 100 as described herein may also be sprouts of the plants or, in other terms, plants in their initial stage of growth following the seed stage, when growth of roots is important.

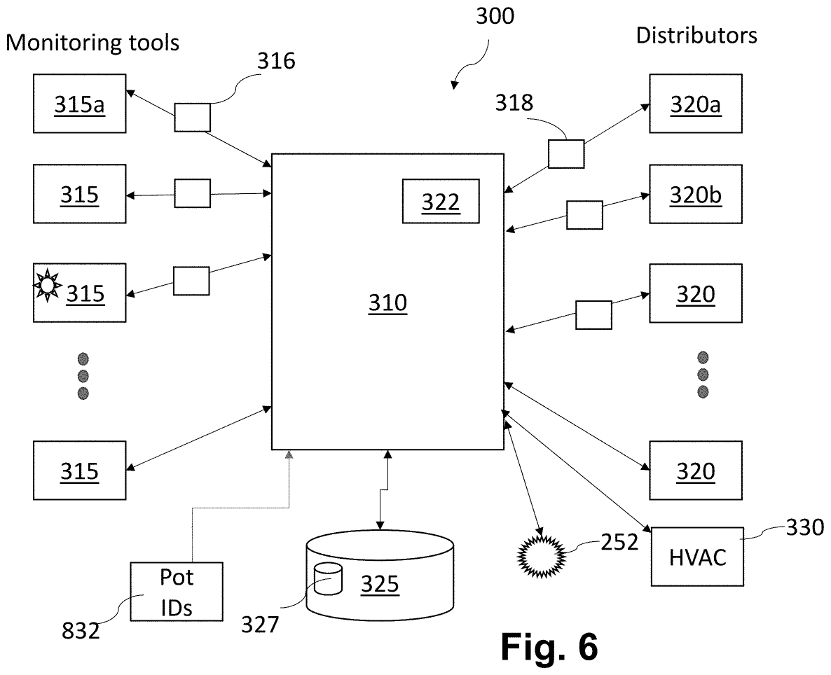

FIG. 6 depicts the monitoring system 300, in accordance with at least one embodiment of the present disclosure. The monitoring system 300 comprises a controller 310 and a plurality of sensors 315. In at least one embodiment, the sensors 315 may be installed at various locations of the apparatus 100 and in a close vicinity of the apparatus 100. For example, some sensors may be installed in a ceiling above the apparatus 100.

Sensors 315 may be, for example: light spectrometer, hyperspectral and thermal imaging cameras, photosynthesis and stomatal conductance meters, soilcamera-rootbox for high throughput root phenotyping, multispectral sensors for determining leaf nitrogen, mobile data acquisition platform for plant canopy measurements and treatments. The monitoring sensors 315 may also be, for example: environmental scanning sensors for air and substrate humidity, air speed, electric conductivity sensors, pH monitors, oxygen sensors, temperature sensors for air and substrate, drainage and irrigation water sensors, spore detectors, and air exchange counter.

In at least one embodiment, growth stages of the plants are characterized by measurement of any one or any combination of stomatal activation, leaf thermoregulation, carbon assimilation, cell elongation, resource allocation (such as, for example: estimated and/or measured surface or volume or mass of different plant parts such as leaves, stem, roots, flowers, fruit), respiration, guttation, root oxygenation, stress response, and by deep learning applied on the newly acquired data based on a training performed on past data.

The controller 310 is connected to distributors 320 which distribute various substances for growth of the plants. The distributors 320 are configured to provide, on demand as received from the controller 310, the following substances to the pods 200: microbial cultures, chemical or biological fertilizers, algal extracts, microbial fertilizers, biopesticides, beneficial insects/microbes and/or Plant Growth Promotion Rhizobacteria (PGPRs) that may be included either in the irrigation system for the pods 200 or may be delivered through tubing which transports water-based solution containing these substances, extending towards the plant location for dripping.

The controller 310 is also connected to a climate system 330 such as, for example, a CO₂, heating, ventilation and air conditioning system (HVAC) (illustrated as HVAC 330 in the drawings) for maintaining humidity in the air according to the physiological stage, air speed (for example, around 0.5 and 2 m/s), environment temperature, and lighting condition. For example, a vapor pressure deficit (VPD) in the HVAC 330 may be determined based on the following equation: VPD=LEAFSVP−(AIRSVP×AIR % RH), where RH is relative humidity, and LEAFSVP and AIRSVP is the sensor data of leaves and air, respectively. For example, the vapor pressure deficit may be approximately 5 g/m³ during light hours and approximately 0.5-1.0 g/m³ at dark. In at least one embodiment, the controller 310 is configured to control the HVAC based on the stage of growth of plants.

The apparatus 100 is connected to a supplemental light system 252 implemented, for example, with light-emitting diodes (LEDs), which may be, for example, LED based water-cooled lights. In addition, during the daylight, the apparatus 100 receives day light and sun light provided through transparent or semi-transparent roof and walls of the greenhouse building. The apparatus 100 may have a light sensor that is configured to determine current lighting (both spectrum and intensity), and regulate a supplemental lighting regime of the supplemental light system 252.

Based on the current conditions (current growth stage of the sprout, kind of the plant of the sprout), the controller 310 may consult the database 325 and determine optimal or advantageous conditions to be applied to the pods (and pots) for root growth of the sprouts.

The controller 310 is configured to request, receive and collect data periodically from the sensors 315 and thus monitor various parameters of the plants. Sensor data 316 from the sensors 315 is collected at each pre-determined data collection time period. For example, the controller 310 may receive and store the data in a database 325 after the expiry of a data collection period. For example, the data collection period may be several days, for example, 3 days.

By collecting the data, the controller 310 may receive information about the following parameters of the plants' physiological processes: Phyllochron development (for example, expressed as ° C. day\hat{ }−1 leaf\hat{ }−1, or in other terms, ° C. per day per leaf or (° C./(day×leaf))); root system development (total root length (cm), surface area (cm²) and root volume (cm³); leaf mineral content; petiole length, petiole color, leaf color, leaf form, leaf area index.

Collected sensor data 316 is analyzed, at the controller 310, for mean square errors followed by deep analysis using convolutional neural networks (CNN), Other agricultural artificial intelligence (AI) and plant intelligence (PI) based approaches may be used.

The controller 310 has a processor 322 and is connected to a database 325. The controller 310 has a software and a hardware that are configured to receive sensor data 316 from the sensors 315, store sensor data 316 and other data in the database 325, process the data to determine adjustments (requirements) which are then transmitted to climate system 330, supplemental light system 252, and the distributors 320.

The controller 310 considers growth stages of the growth cycle of the sprout. For each growth stage, the controller 310 determines the adjustments (requirements) that are then transmitted to the distributors 320 and to the supplemental light system 252 and climate system 330 and requests to adjust the plant environment conditions. The plant environment conditions may be, for example, light, temperature, humidity, watering, application of fertilizers, and speed of the revolving pods 200.

The controller 310 adjusts the operation of the supplemental light system 252 (both spectrum and intensity). The supplemental light system 252, which may be supplemental in comparison with daylight which may be transmitted into the area where the plants are grown (e.g., in a greenhouse inner area or the like) emits light with the spectrum and intensity adjusted to match the optimal spectrum and intensity determined and requested by the controller 310. The spectrum and intensity for the supplemental light system 252 is determined by the controller 310 based on a current growth stage of the sprout, kind of the plant of the sprout, in order to prioritize root growth in growing plants. Thus, the spectrum and intensity of the light emitted by the supplemental light system 252 varies in time, based on the requests transmitted by the controller 310.

The controller 310 also determines an appropriate temperature for the growth stage and appropriate humidity. In addition, the controller 310 determines advantageous temperature and humidity conditions for each kind or the variety of the sprout (i.e. the variety of the plant which is being nurtured), and, based on pot IDs 832 of the pots 830 located in a cradle 100, transmits requests to the climate system 330. The climate system 330 may be configured to maintain different conditions (such as temperature and humidity) for each cradle 100 located in the greenhouse building 801.

The distributors 320 provide various substances to the pods 200 based on the requests received from the controller 310. For example, one of the distributors 320 may be a liquid fertilizer distributor 320a which adds a fertilizer (for example, one of fertilizers described above) requested by the controller 310 to the liquid 145 that is located in the tray 140.

For example, the controller 310 may determine, for a specific growth stage, a nutrient recipe for the fertilizer having various fertilizer components, such as, for example: low nitrogen, low potassium and high calcium recipe (for example, pH 5.8 EC 0.8, 1.0 and 1.2 during first, second and third week). In some embodiments, the controller 310 determines that that a compost tea needs to be applied, microbe-based fertilizers, yeast, and/or algal extract. In addition, the controller 310 may determine that the substrate moisture needs to be maintained at 2-3 kPa during the day and ˜3-5 kPa during the dark. It should be understood that the fertilizer may have all or several or one of the fertilizer components described herein.

For example, the controller 310 may determine that, at a current growth stage, the plants need to be treated with one or more of the following fertilizer components which need to be distributed, and, in some embodiments, mixed by one or more distributors 320: vegetative nutrient media (vegetal mafter or substrate), along with algal extract, microbial fertilizer, PGPRs, mychorrizhae (80, 12, 5, 2.5 and 0.25%) as root treatment, Foliar treatment with 1% hydrogen peroxide, 2% seaweed extract, canola oil, microbes (Bacillus, Streptomyces, Trychoderma, Gliocladium and Beauveria species). For each growth stage, the controller 310 transmits to the distributors 320 a request to distribute, and, in some embodiments, mix the determined kind and quantity of each fertilizer component (treatment).

In some embodiments, all or some of the distributors 320 are configured to distribute the fertilizer(s) to the liquid 145 in the tray 140. In some embodiments, direct tubing may be used to provide the fertilizer(s) to the liquid (liquid drip) which drips into the pods 200. In at least one embodiment, the controller 310 is configured to receive the sensor data 316 from the sensors 315, to determine commands 318 based on the stage of growth of the plants as provided by the sensor data 316, and transmit the commands 318 to the distributors. The distributors 320 may be configured to mix the fertilizer components as provided by and in response to receiving command(s) 318 in order to produce the fertilizer(s).

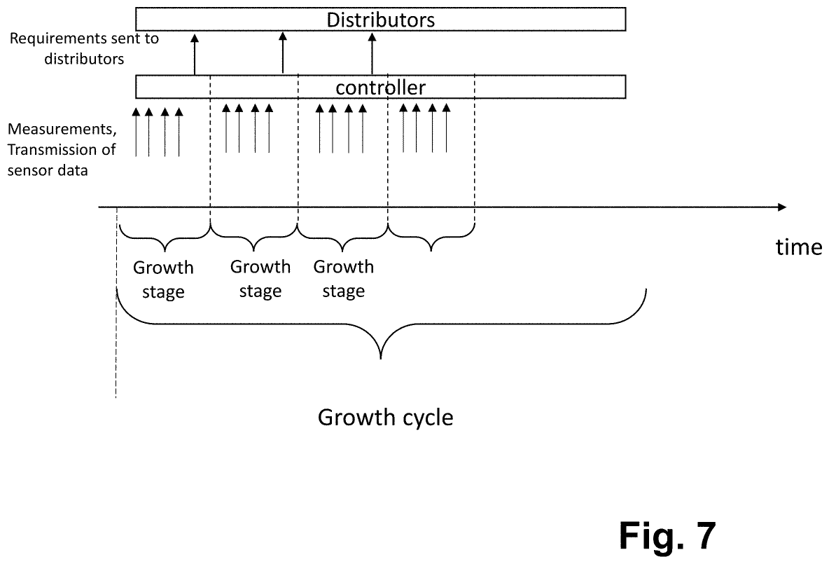

The controller 310 also, depending on the growth stage of the plants, may transmit a request to an insect distributor 320b which may be one of distributors 320 which distributes insects that may improve the growth of the plants. FIG. 7 schematically illustrates a growth cycle and transmission of the sensor data and requests in time, in accordance with at least one embodiment of the present disclosure.

Upon appearing of the first open flowers of the plant in a pot 830, detected by one type of the sensors (e.g., camera), the controller 310 displays or otherwise makes noticeable a notification to the operator that the growth cycle of the sprout has ended and the plant in the pot 830 needs to be transported to the vertical agriculture module 870 (also referred to herein as a “vertical farm unit 870”). For example, the root colonization may be achieved in 14 days, followed by leaf growth. For example, the notification may be sent when a pre-determined number of leaves are grown (for example, 2 or 3 leaves). In another example, the notification may be sent when the first truss in a strawberry plant appears.

FIGS. 5A-5C depict a bottom section 130 of the apparatus 100 in accordance with at least one embodiment of the present disclosure. Each pod 200 has at least two containers 510 arranged parallel (or approximately parallel) to each other, as schematically depicted in FIG. 5D. In some embodiments, the containers 510 have bottoms positioned at an angle to the ground and a top surface of the soil 512 positioned at an angle to the ground, such that the light could reach most of the plants (sprouts) located in the container 510. At the bottom of the containers 510, there are heels 515.

The heel(s) 515 improve placement of the container 510 on a shelf (not shown) by helping to maintain the bottom of the containers 510 and the top surface of the soil 512 at the angle to the ground when the containers are placed on the shelves (not shown) after the plants have been grown in the apparatus 100. The heel 515 may be a protrusion at the bottom of the container 510. The containers 510 are attached to the cable 110 via a container holder 532 and screw(s) 534.

A portion of the container 510 that is dipped in the liquid 145 is defined by a dipping depth 544, which is the distance between the lowest corner of the container 510 and the surface of the liquid 525. By controlling a liquid's depth 540 in the tray 140, the dipping depth 544 may be also controlled and adjusted by the controller 310.

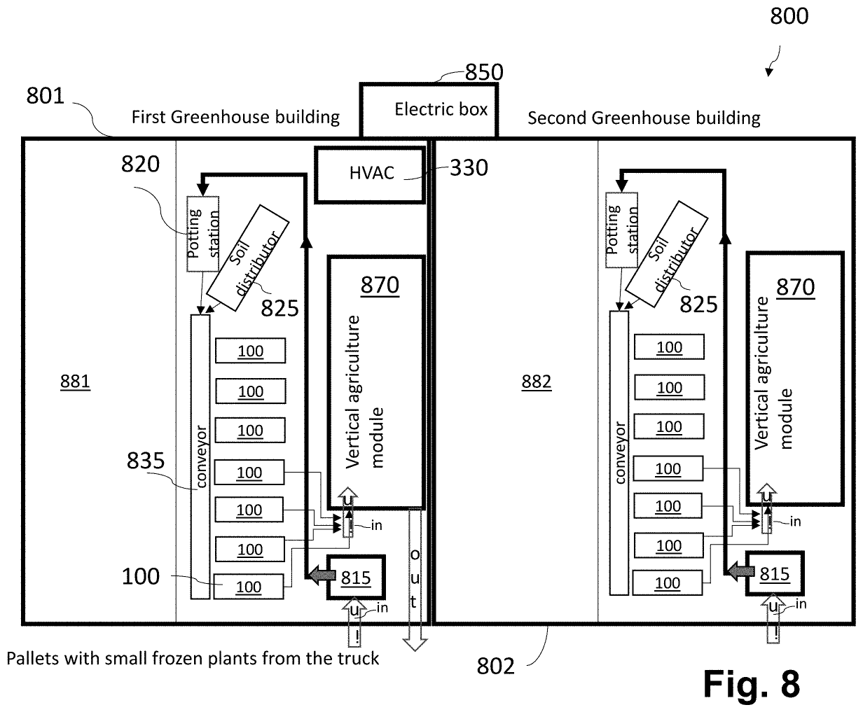

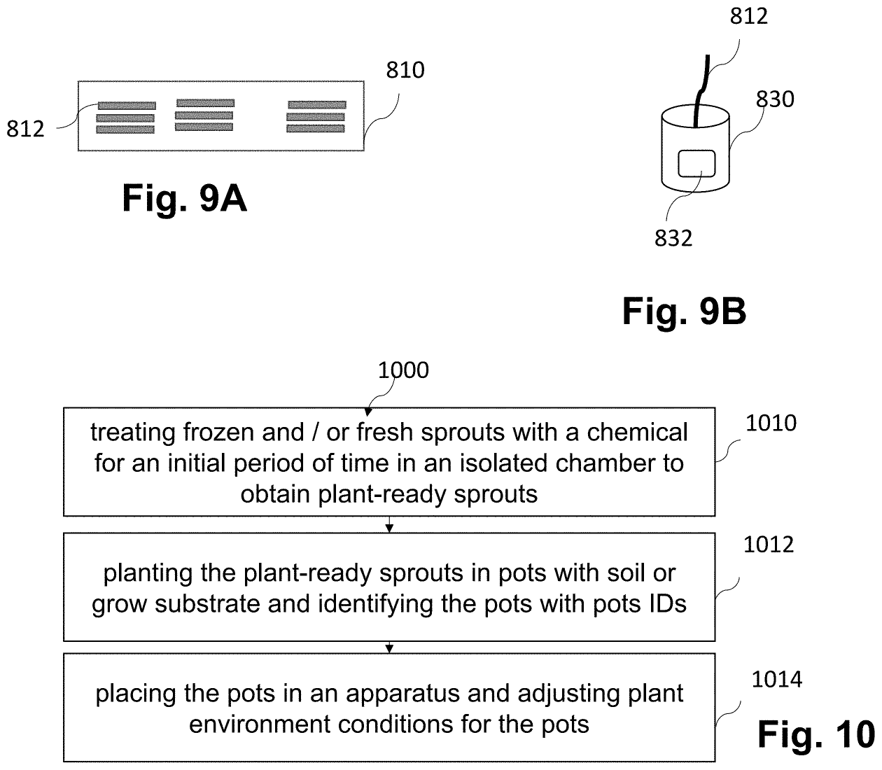

Referring now to FIG. 8, and according to an embodiment of the disclosure, a joint greenhouse 800 comprises a first greenhouse building 801 and a second greenhouse building 802 (referred to collectively as “greenhouse buildings 801, 802”) which may have one mutual wall. Pallets 810 (illustrated in FIG. 9A not proportionally with the greenhouse buildings 801, 802) with frozen sprouts 812 (in other terms, small plants that may be used for planting) are received and are placed in a chemical chamber 815. The sprouts are kept at temperatures equal to or lower than 0 Degree Celsius to simulate the winter conditions. Such simulation of winter conditions imitates real-life conditions, when the plants are planted in autumn, and wake up and resume growth during the springtime.

It should be noted that a sprout 812 may also be referred to as a stalk. For example, for a strawberry plant, a sprout 812 may also be referred to as a stalk or a runner.

The chemical chamber 805 is located in the greenhouse building 801. After the sprouts 812 are placed in the chemical chamber 815, the chemical chamber 815 is hermetically isolated (airtight) from the environment outside of the first greenhouse building 801 and from the atmosphere inside the first greenhouse building 801. A treatment solution with cleaning chemicals is provided to the chemical chamber 815, such that the sprouts 812 are subjected, during a pre-determined chemical treatment time period (also referred to herein as an initial period of time), to these chemicals to kill insects and to kill any microbes that may cause development of diseases in sprouts and later in the plants. The chemicals used in the chemical chamber 815 may be, for example: Oxidate 2.0 hydrogen peroxide and peroxyacetic acid, Milstop potassium bicarbonate foliar fungicide, Actinovate™ SP fungicide Streptomyces lydicus strain WYEC108, OxiDate™ 2.0, hydrogen peroxide, Actinovate™ SP, Milstop, and/or RootShield™ Plus.

The sprouts 812 may also be subjected to differential humidity, temperature, oxygen, carbon dioxide and nitrogen levels in order to disinfect/clean the sprouts 812.

For example, before and/or after exposing the sprouts 812 to chemicals, the sprouts 812 may be screened for infections to select the sprouts 812 for the next stage of the process.

After the sprouts 812 have been treated in the chemical chamber 815, the isolation between the chemical chamber 815 and the outside environment of the first greenhouse building 801 is opened and the chemicals are evacuated outside of the first greenhouse building 801 while observing the material safety requirements and time periods. The sprouts 812 are then transported from the chemical chamber 815 to a potting station 820 which is neighboring a soil/substrate distributor 825.

The soil/substrate distributor 825 (FIG. 8) is configured to distribute a substrate, such as a silicon-based substrate or another commercial substrate, which is placed into the pods 200 at the potting station 820. The silicon-based substrate may be, for example, a silicon-based substrate with 45% perlite, 45% peat moss and 10% wood chunks. A commercial substrate may be used, such as, for example, Sungrow S4. In at least one embodiment, the controller 310 may generate and transmit requests to the soil/substrate distributor 825 to provide a specific substrate, Such request may be generated, for example, based on the kind of the plants/sprouts being potted. In addition, the controller 310 may transmit a request to the soil/substrate distributor 825 or directly to the potting station 820 to distribute additional substances in the pods 200, such as those described with reference to distributors 320 above. In some embodiments, the distributors 320 may provide the substances to the potting station 820 (and/or soil/substrate distributor 825) on the request of the controller 310.

Each sprout 812 is positioned inside a pot 830 and soil is added to the pot 830 by the soil distributor 825. The pots 830 are then transported, by a conveyor 835 to cradles 100, Cradles 100 are located in the first greenhouse building 801.

For example, as illustrated in FIG. 5D, four plants 812 may be planted in one container 510 (directly or with an additional pot 830) of 6 liters with a substrate (bottom) of the container 510 arranged at angle of, for example, 45-degree outwards from the vertical of the pod 200. As illustrated in FIG. 5D, the pots 830 may be placed in containers 510, each container 510 may have two or more pots 830. Each container 510 may have several pots 830 with sprouts 812 planted therein as described below. Alternatively, several sprouts 812 may be planted in one container 510 directly. In such an embodiment, the pots 830 are the same as containers 510 in the description herein. Planting may be done at 20% substrate humidity level while maintaining 0.8-1.2 EC and 5.6-6.0 pH at grow media level.

The containers 510 are then placed into the plant pod 200 as discussed above and depicted in FIG. 5D. Each pot 830 (or a container 510 if the sprouts are planted directly into the containers 510) is assigned a pot identification (ID) 832 schematically depicted in FIG. 9B. Each pot ID 832 is recorded along with the information about a kind of sprout(s) it has (for example, if the sprout 812 is for a strawberry, then the kind of sprout may correspond to a strawberry variety of the sprout), the time of planting, and other initial sprout-related information which is now assigned to each pot 830. The initial pot information is transmitted to the controller 310 and recorded into the database 325. A pot database 327 may be, for example, a part of the database 325 described above. For example, a sprout 812 may have a tag attached to it with a bar code at the arrival to the first greenhouse building 801. Later, the same bar code or a different one may be used to identify the pot 830 (or container 510) where the sprout(s) is(are) planted.

Referring again to FIG. 8, the second greenhouse building 802 has the same installations as the installations described above for the first greenhouse building 801 except for HVAC 330, which is one for both greenhouse buildings 801, 802. The electric box 850 is also one for both greenhouse buildings 801, 802. Two greenhouse buildings 801, 802 are operating asynchronously with a 12-hour delay. That is, when one of the greenhouse buildings 801, 802 operates in daytime conditions, the second building of the greenhouse buildings 801, 802 operates in the nighttime conditions. Such delay of operation of two greenhouse buildings results in a constant consumption of energy which at every given time provides daytime conditions to one of the greenhouse buildings 801, 802, and nighttime conditions to another building.

The daytime conditions and nighttime conditions as referred to herein are determined by lighting (spectrum and intensity), temperature and humidity. The daytime refers to a 12-hour period that would be between approximately the sunrise and sunset. The nighttime refers to a 12-hour period that would correspond to a time period between approximately the sunset and sunrise. The daytime and nighttime conditions arranged in the greenhouse for the sprouts located in the cradles 100 are simulated based on determination, using deep learning methods, of advantageous growth conditions for roots of the sprouts 812. The duration of the daylight condition may vary to reflect the natural variation, but the overall energy is likely to be approximately the same over that period, such that stretching the daily daylight duration spreads the energy over time and the addition of energy consumption at a given time by the 2 different alternate rooms is mostly constant over time during a given 24-hour period.

Referring also to FIG. 6, the controller 310 controls all plant environment conditions that are applied to each particular pot 830 (alternatively, to a pod 200).

Referring again to FIG. 6 and FIG. 8, each cradle 100 has one or more corresponding units of the supplemental light system 252® for example, located above the cradle 100, which are operated and controlled by the controller 310 based on the sensor data 316 and the data about each one of the sprouts 812 located in the cradle 100.

The controller 310 optimizes the plant environment conditions. The plant environment conditions are, for example, lighting, temperature, humidity, fertilizers. The plant environment conditions are adjusted by the controller 310 as a function of time and growth stage of the sprout/plant, in order to prioritize growth of roots of the plants from the sprouts. Only after the root system has been developed, the plant environment conditions may be adjusted to prioritize growth of the leaves.

In some embodiments, the monitoring system 300 may have root sensors (for example, installed at the bottom of the pot 830 or inside the pod 200) configured to determine whether the roots of the plant have sufficiently grown. Alternatively, an operator may mechanically check bottoms of each pot 830 (or container 510) to visually determine whether the roots have grown enough to place the pot 830 or the container 510 or the whole corresponding pod 200 to a vertical agriculture module 870 (illustrated in FIG. 8). In at least one embodiment, each container 510 is attached to the pod 200 such that the bottom of the container 510 is exposed and thus the roots are visible on the bottom surface of the container 510 even when the container 510 is attached to the pod 200 and the pod is attached to the cradle 100. As described above, the container 510 may be placed on the shelves of the vertical agriculture module 870 using the heels 515 that are placed on the shelves and ensure the inclination of the top surface of the soil 512.

The vertical agriculture module 870 is configured for the plants that already have grown roots and leaves. The grown plant conditions (such as temperature, humidity, fertilizers, etc.) inside the vertical agriculture module 870 is different from the conditions (such as temperature, humidity, fertilizers, etc.) provided for the cradles 100.

In at least one embodiment, the first greenhouse building 801 may also comprise a first greenhouse section 881, and the second greenhouse building 802 may also comprise a second greenhouse section 882.

Elements in the environment may be optimized to ensure proper material flow of the plants and equipment, in view of the rotation of the plants in and out of the vertical agriculture module 870. For example, dedicated paths of transport may be installed inside the facility (first greenhouse building 801 and/or greenhouse buildings 802). Machinery may be used to put soil or grow substrate in the pot 830 to receive the unfrozen plant. Additional conveyors (such as, and in addition to the conveyor 835) may be used to bring a volume of plants in pots toward the cradles, where a rack, which may have wheels in rails, and with an inclined surface thereon, may be used to receive pots from the conveyor for rapid redistribution onto the cradles 100. A similar path may be used for removal from the cradles 100 and displacement and introduction of the pods 200 and/or containers 510 into the vertical agriculture module 870.

Referring again to FIGS. 1-3B, the apparatus 100 for growing plants comprises: a first tower 102a and a second tower 102b located adjacent to each other and forming an outside perimeter surface 170, the outside perimeter surface comprising two surfaces of opposite sides of the first tower 102a, two surfaces of opposite sides of the second tower 102b, and bottom portions of the first tower 102a and the second tower 102b; a tray 140 located in the bottom of the outside perimeter surface 170; and a cable system 106 configured to pull a plurality of pods 200 along the outside perimeter, each pod 200 having two containers 510 positioned parallel to each other and to the outside perimeter surface 170, the cable system 106 having a deepest wheel 530 configured to bring at least one pod 200 of the plurality of pods in a contact with a liquid 145 located in the tray 140.

Referring to FIG. 6, the plant growth monitoring system 300 comprises: a plurality of sensors; a plurality of distributors configured to distribute fertilizers in response to the received commands; and a controller configured to: receive a sensor data from the plurality of sensors, determine commands for a stage of growth of plants; transmit the commands to the distributors.

Referring to FIG. 10, a method 1000 of initiating a plant in preparation of its introduction into a vertical farm unit, as described herein, comprises: at step 1010, treating frozen sprouts with a treatment solution (comprising chemicals) for a first period of time in an isolated chamber 815 to obtain plant-ready sprouts; at step 1012, planting the plant-ready sprouts in pots 830 with soil or grow substrate and identifying the pots with pots IDs 832; and, at step 1014, placing the pots in an apparatus and adjusting plant environment conditions for the pots.

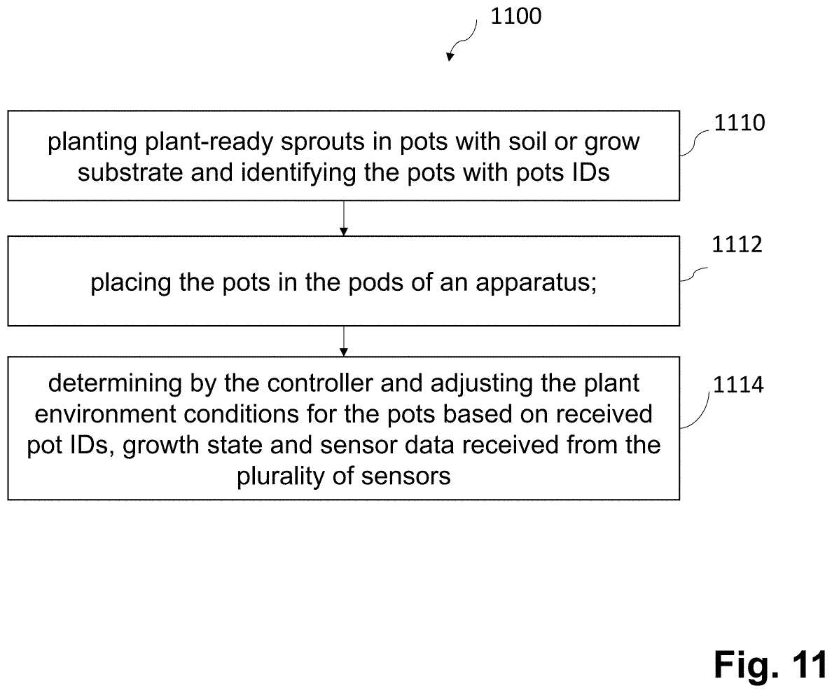

Referring now to FIG. 11, and with reference also to FIGS. 2 to 6, a method 1100 of initiating a plant in preparation of its introduction into a vertical farm unit 870, the method to be performed in a system comprising: an apparatus 100 configured to rotate pods 200 with sprouts 812 to periodically expose different sprouts placed in the pods 200 to plant environment conditions, a controller 310 having a processor and configured to determine and request to modify the plant environment conditions, a plurality of sensors 315; the method as described herein comprises: planting plant-ready sprouts in pots with soil or grow substrate and identifying the pots with pots identifications (IDs) 832; placing the pots 830 in the pods 200 of the apparatus 100 and adjusting plant environment conditions for the pots 830 based on received pot IDs 832, growth state and sensor data 316 received from the plurality of sensors 315. As described above, prior to planting the plant-ready sprouts, frozen sprouts may be conditioned and/or treated with a chemical for an initial period of time in an isolated chamber 815 to obtain the plant-ready sprouts. Adjusting the plant environmental conditions may comprise temperature based on a temperature value determined by the controller 310. Adjusting the plant environmental conditions may comprise adjusting lighting based on a spectrum and intensity determined by the controller 310. Adjusting the plant environmental conditions may comprise adjusting humidity based on humidity value determined by the controller 310. Adjusting the plant environmental conditions may comprise providing or adjust of providing fertilizers to the plants in an amount and type as determined by the controller 310. Adjusting the plant environmental conditions may comprise adjusting a speed of revolving pods 200 (also referred to herein as a pod revolving speed). The pod revolving speed may be adjusted in response to received commands from the controller 310. The method 1100 may further comprise distributing fertilizers in response to received commands from the controller 310. In at least one embodiment, the controller 310 determines the plant environment conditions by using convolutional neural networks (CNN).

1. An apparatus for growing plants, the apparatus comprising:
a first tower and a second tower located adjacent to each other and forming an outside perimeter surface, the outside perimeter surface comprising two surfaces of opposite sides of the first tower, two surfaces of opposite sides of the second tower, and bottom portions of the first and the second towers;
a tray located in the bottom of the outside perimeter surface; and
a cable system configured to pull a plurality of pods along the outside perimeter, each pod having two containers positioned parallel to each other and to the outside perimeter surface, the cable system having a deepest wheel configured to bring at least one pod of the plurality of pods in a contact with a liquid located in the tray.

2. The apparatus of claim 1, wherein the cable system comprises gears and a chain, the deepest wheel being one of the gears.

3. The apparatus of claim 1, further comprising a controller configured to operate a motor for pulling the cable system along the outside perimeter surface.

4. The apparatus of claim 1, wherein the tray has tray wheels for moving independently of the first tower and the second tower, wherein the first tower and the second tower are immovable with respect to each other.

5. The apparatus of claim 1, further comprising a controller configured to control a depth of the contact of the at least one pod with the liquid located in the tray.

6. The apparatus of claim 1, further comprising:
a plurality of sensors;
a plurality of distributors configured to distribute fertilizers in response to received commands; and
a controller configured to:
receive a sensor data from the plurality of sensors,
determine commands for a stage of growth of plants based on plant identifications and the sensor data;
transmit the commands to the distributors to deliver the fertilizers to the tray and the containers, wherein at least one of the fertilizers is distributed to the tray.

7. A plant growth monitoring system comprising:
a plurality of sensors;
a plurality of distributors configured to distribute fertilizers in response to received commands; and
a controller configured to:
receive a sensor data from the plurality of sensors,
determine commands for a stage of growth of plants;
transmit the commands to the distributors.

8. The plant growth monitoring system of claim 7, wherein the distributors are configured to mix fertilizer components to produce the fertilizers.

9. The plant growth monitoring system of claim 7, wherein determining commands for a stage of growth of plants is based on pot identifications related to the plants and received by the controller.

10. The plant growth monitoring system of claim 7, wherein the controller is further configured to control the heating, ventilation and air conditioning system based on the stage of growth of the plants.

11. (canceled)

12. A method of initiating a plant in preparation of its introduction into a vertical farm unit, the method to be performed in a system comprising:
an apparatus configured to revolve pods with sprouts to periodically expose different sprouts placed in the pods to plant environment conditions,
a controller having a processor and configured to determine and request to modify the plant environment conditions,
a plurality of sensors;
the method comprising:
planting plant-ready sprouts in pots with soil or grow substrate and identifying the pots with pots identifications (IDs);
placing the pots in the pods of the apparatus; and
determining by the controller and adjusting the plant environment conditions for the pots based on received pot IDs, growth state and sensor data received from the plurality of sensors.

13. The method of claim 12, further comprising, prior to planting the plant-ready sprouts, treating frozen and/or fresh sprouts with a treatment solution for an initial period of time in an isolated chamber to obtain the plant-ready sprouts.

14. The method of claim 12, wherein adjusting the plant environmental conditions comprises temperature based on a temperature value determined by the controller.

15. The method of claim 12, wherein adjusting the plant environmental conditions comprises adjusting lighting based on a spectrum and intensity determined by the controller.

16. The method of claim 12, wherein adjusting the plant environmental conditions comprises adjusting humidity based on humidity value determined by the controller.

17. The method of claim 12, wherein adjusting the plant environmental conditions comprises providing or adjust of providing fertilizers to the plants in an amount and type as determined by the controller.

18. The method of claim 12, further comprising distributing fertilizers in response to received commands from the controller.

19. The method of claim 12, wherein the controller determines the plant environment conditions by using convolutional neural networks (CNN).

20. The method of claim 12 further comprising adjusting a pod revolving speed in response to received commands from the controller.
